(19) United States
(12) Patent Application Publication
(10) Pub. No.: US 2021/0315769 A1
(43) Pub. Date: Oct. 14, 2021

(54) Universal Ischemic Compression Device

(71) Applicant: Bardia Shemiranipour, (US)

(72) Inventors: Bardia Shemiranipour, Houston, TX (US); Stephen Love, Houston, TX (US)

(73) Assignee: Bardia Shemiranipour, Carlsbad, CA (US)

(21) Appl. No.: 17/220,402

(22) Filed: Apr. 1, 2021

Related U.S. Application Data
(60) Provisional application No. 63/007,014, filed on Apr. 8, 2020.

(51) Int. Cl. A61H 23/00

(52) U.S. Cl. CPC A61H 23/006; A61H 2201/0107; A61H 2201/5023; A61H 2201/0165; A61H 2201/0153

(57) ABSTRACT

This invention is a universal ischemic compression device for self-treatment with interchangeable treatment modes providing people of varying abilities with a true self-treatment device with sustained and uninterrupted ischemic compressional framework. The interchangeable treatment modes (referred to as interchangeable treatment units) include a universal adaptor used to dock or insert a pre-existing or pre-owned massage therapy device. Another is an all-in-one unit that contains ischemic and percussive force mechanisms and may be extended with a handle that may be adjusted to user preference. The user specifies massage settings through a control panel for operation on the device. The rotating massage head receiver allows the user to interchange different massage heads to allow for multiple treatments from a single base unit. Another interchangeable treatment mode is an ischemic compression hook for static pressure point release.

### CROSS REFERENCE TO RELATED APPLICATIONS

This application claims priority back to U.S. Provisional Application No. 63/007,014, with a filing date of Apr. 8, 2020, the contents of which are incorporated by reference into this utility patent application.

### STATEMENT REGARDING FEDERALLY SPONSORED RESEARCH OR DEVELOPMENT

This invention was not federally sponsored.

### BACKGROUND OF THE INVENTION

### Field of the Invention

This invention relates to the general field of health and wellness, and more specifically toward a multifunctional and universal ischemic compression device and interchangeable treatment units that is provided a retrofit version to which a person with an existing massage device can attach for self-treatment, a complete package version, and a static trigger point release function.

### Statement of the Problem Solved

Handheld massage devices have become a “must-have” tool in every fitness enthusiast and active person's toolbox. It has become so widely used that most massage therapists, chiropractors, physical therapists, and other therapy service men and women use it on their respective patients and clients. Percussion devices, massage devices, or percussion guns as they are referred to, are only available in similar shapes and sizes across the market. The most common shape (˜96%) is that of an electric screwdriver or a jigsaw. The form of current devices require the user to hold it in his or her hand (similar to that of a jigsaw) and apply the massage onto themselves, reaching only the front areas of the body with ease. The problem is that these massage devices are difficult to use on the shoulders or back areas of the body because it becomes too hard and strenuous to hold the devices in awkward angles and for extended periods of time in an attempt to reach the shoulder and back areas of the body. Even more so, the older population suffering from arthritic pain, joint instability, and general weakness are unable to use such devices because they are too heavy to hold upright in an attempt to self-treat shoulder, back, and general body pain. The current invention allows the user to attach a pre-existing pre-owned massage device to the invention and immediately reach all those hard to reach areas without over stressing other parts of the body, a true solution for all age range and physical capabilities. The Universal Ischemic Compression Device and extension system is well suited for those who have already purchased a massage therapy device and want to maximize usability. The “all-in-one” unit is designed for those users who may not possess an existing massage device and wish to have both the mechanical component of a percussion massager combined with a reachable and adjustable handheld all in one. The all-in-one device also helps maximize efficiency, usability, and accurate treatment delivery. In addition to the bodily benefits of percussive and varying frequency vibrational modes, a sustained ischemic compression is significantly more advantageous when combined. Amongst other benefits, current invention is equipped with three interchangeable delivery units allowing for optimal comfort and better results.

### Prior Art

There is considerable prior art that attempts to allow a person to self-treat The prior art includes U.S. Pat. No. 6,805,679B2 for a “Hydrocussion Massager”, however this invention requires being hooked up to a shower or faucet, and relies on water pressure rather than a physical percussion to treat a back or neck area. There is also no ability to exchange different treatments delivery modes or to substitute in existing massage devices.

The prior art also includes US Patent Publication No. US20080154161A1 “Handheld Massager”, however this invention has an oil reservoir and wicking element. This may allow for the possibility of leakage and flammability issues. This also may allow for lubricant buildup in the device. A third prior art is U.S. Pat. No. 7,699,794B2 for a “Massager with Shock Absorption, Multiple Contact Surfaces and Visual Therapy Effects”, however this invention does not allow for the extension of the device for hard to reach areas of the neck and back areas.

A fourth prior art is US Patent Publication No. US20170304145A1 for a “Handheld Massage Device, however this invention does not include an extension for hard to reach areas. This device is solely for direct contact of easy reach muscles, however would require another person to apply back and neck area, and even for areas that a person could reach for self-treatment, it is likely that the strain on the person's hands, wrists, elbows and shoulders would outweigh the benefits of the massage. There is also US Patent Publication No. US20100274162A1 “Thermal Massager”, however this invention does not include attachments. This device also has an oil reservoir and has a heating unit. This may allow for the possibility of leakage and flammability issues. This may also allow for lubricant buildup in the device.

Additional prior arts search was concluded Mar. 16, 2021—see pdf attached. A fifth prior art is U.S. Pat. No. 6,261,251B1 for a “J-shaped massage device having a vibrator.” However, unlike current invention, this invention does not allow for the ability to attach any pre-owned device and the adaptability to a wide selection of massage devices already in use by consumers, and it only vibrates at ultra-low frequency and does not produce percussion thrusts.

So, there are percussion massage devices in the prior art, and some even attempt to be “self-treatment” devices. However, although there have been many attempts, none of the prior art offers an extensional adaptor apparatus for percussion therapy and massage devices to help the user reach the hard areas of the body, like the neck and shoulder areas and the posterior aspect of the body, without overstressing other parts of the body or straining the arm or with maintaining odd angles. In order for the user to receive an effective experience, a partner must be present to help hold the device and administer the treatment all over the users back side (posterior) both upper and lower extremities.

The current invention provides just such a solution by offering a handheld device that delivers percussive and ischemic compression treatment to a person's back while being held and controlled by that person, without requiring that person to overstress his/her arms, neck and shoulder while attempting to maintain uncomfortable positions. The invention provides user-selectable types of treatment for varying types of therapy needs with its interchangeable unit capabilities, all providing ergonomically elongated dimensions for handheld grip and total body accessibility and efficient ischemic compression. Invention allows the use of any existing and pre-owned massage therapy device, as it merely docks to the universal adaptor unit. The extensibility of the invention allows for effective treatment by enabling the user to independently target the hard to reach areas of the body. One embodiment of a all-in-one unit combines a interchangeable mechanical and electric hardware of a massage delivery system with the elongated and telescoping handle, allowing the user to reach all the hard areas of the body, including but not limited to the neck, upper and middle trapezius, middle back region, thoracic area, lower back, both sides of the hips and buttocks, back of the legs, gastrocs, feet, and more generally the overall body without the difficulty and excessive strain placed on other parts of the body. Current invention has been revised from provisional patent filing to improve overall usability. One embodiment of a static, fixed hook attachment delivering ischemic compression without electrical components. All variations are interchangeable with a mounted-spring-pin-lock-release system that has been specifically designed for the function of changing between the interchangeable units of this invention.

### SUMMARY OF THE INVENTION

It is a principal object of the invention to provide a universal attachment, extension, and docking system of a multifunctional and interchangeable ischemic compression device. This allows the use of any massage therapy device with the invention and maximizes usability with ease. The universal adaptor with its extensibility allows the user to lengthen the grip area and the height of the attachable therapy device that allows the user to seemingly hold the handle and effortlessly treat all those hard to reach areas of the body.

It is another object of the invention to provide an easy method for use and cost-effective solution for a self-guided massage device that can reach the body in its entirety and other previously unreachable treatment locations. Users who have already spent a great deal of their hard-earned cash to purchase a percussion massage unit, therapy device, massage gun, and are looking for a solution to help them mount or dock an existing pre-owned massage device to an elongated handle, in order to massage hard to reach areas of the body that current devices on their own are difficult or impossible to use or without the help of someone else holding the device in order for the receiver to fully benefit from the treatment. Researchers Hou and colleagues (2015), amongst many other scientists suggest that sustained and uninterrupted pressure from an object at a high intensity (maximum threshold) for a low duration (30 seconds) or at a low intensity (minimal pain threshold) for a longer duration (90 seconds) significantly reduced pain and trigger point sensitivity. The practical significance is that by holding pressure on the tender areas of tissue for a sustained and uninterrupted period increases muscle extensibility of the shortened muscles and provides for optimal length-tension relationships. Percussion massage devices currently out in the market (cited devices) does not allow sustained and uninterrupted pressure for 30-90 sec due to the difficult nature of maintaining the handheld-massage and its treatment structure on muscles long enough to have effective outcome described above, particularly the back areas of the body, because it is difficult to hold the devices without straining the arms and shoulder in an attempt to reach the back.

A further object of the invention is to provide an all-in-one device that allows the user to purchase one device that maximizes massage reachability and usability. The all-in-one combines the wireless mechanical hardware apparatus of a massage delivery system equipped to run at variable speeds, with more defined ergonomic shape and functionality. By extending the handle area, and lengthen the height and reach of the percussion delivery system. The user can effectively and ergonomically reach areas of the body previously difficult to treat independently. The all-in-one which includes but not limited to the power source, motor, housing, shaft, gearbox, driver and massage head as a single unit is detachable from the pole and handle so that the user can also treat anterior regions of the body.

An additional object of the invention calls for a device that can provide comfort in any anatomical position. With current available percussion massage devices/guns, it is difficult to use in relaxed positions such as lying down, on the side of the body, or the stomach. One cannot simply lie down on his/her side and receive the treatment comfortably without someone present and willing to help administer the massage. The invention, with its ergonomic design and shape, allows the user to receive the full benefits of percussion therapy and precision targeting while maintaining a relaxed and various anatomical position.

A further object of the invention provides independence for a person desiring (or needing) treatment of his/her back. The invention allows users to become more independent due to the invention's ability to reduce or eliminate musculoskeletal inhibitions, particularly areas of the body which are most susceptible to pain and injuries, without the need for someone holding a massage device and rendering the treatment. It also enables and promotes social distancing.

Another object of the invention is to provide a treatment device that reduces body pains, aches, and tightness as compared to the prior art. Those made of softer, less rigid materials will have an effect on more superficial layers of the fascia, whereas tools that are more modular, harder, and rigid will increase pressure on soft tissue structures and access deeper layers of the fascia (Curran et al. 2008).

A further object of the invention is to provide a device suitable for the older population who find it difficult to hold massage devices of prior art due to arthritic pain and strength limitations. Current invention will provide independence, promote safe self-treatment options for all age groups with various physical abilities and functional disabilities, and reduce excessive need for ongoing provider-based therapy and by doing so reducing healthcare cost.

Another object of the invention is to provide noise and vibrational force reduction. The inner lining of the dock housing acts as a sound wave barrier, reducing motor sound and dampens vibration from most pre-owned massage devices and those in prior art. Adjustable sleeve and padded interlinings with additional strips run along the inside of the dock housing to adapt to the contours of various devices and reduce noise from vibration and translational vibration along the handle. Other mounting apparati are incompatible with looped handle percussion devices. The function of the dock, neck, and length of the invention is constructed to damp vibration and equally distribute mechanical vibrations from the motor along the pole and handle. Unlike other devices and prior art, the user feels less shakiness from invention and no longer needs to tightly grip the device causing grip fatigue and wrist pain.

Another object of invention is to provide relief of muscle pains and tightness. Improves function, mobility and quality of life. And by mobilizing, reduce associated stress and depression.

Another object of invention is to provide user relief of having to carry or stow multiple massage devices by providing a one complete package that unites them all.

Another object of invention is to help reduce excessive waste of plastic and other materials used to construct therapeutic tools of limited capabilities.

Another object of invention to give regular people the right tools to help themselves alleviate muscle tightness, pains, inhibitions, and recover. Prior art and existing percussion massage devices (with various sizes and shapes in the market) are mainly used by massage therapists, chiropractors, physical therapists, and other therapy service men and women to treat their respective patients and clients due to the fact that it is more effective when used in such manner. The active population and even more the general population is at a disadvantage by their inability to access hard to reach areas of the body with efficiency and precision targeting when applied on themselves. Since majority of muscular stress and thus inhibition is accumulated around the upper trapezius, and a significant number of the population suffer from low back pain due to desk jobs or and other causes, it is easy to rationalize the need for this invention which equips individuals to effectively self treat and minimize preventable healthcare costs. Furthermore, individuals with shoulder pain/injury are unable to lift their arms high enough to self-treat with prior art and current massage devices available in the market.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto. The features listed herein and other features, aspects and advantages of the present invention will become better understood with reference to the following description and appended claims.

### BRIEF DESCRIPTION OF THE FIGURES

The accompanying drawings, which are incorporated in and form a part of this specification, illustrate embodiments of the invention and together with the description, serve to explain the principles of this invention.

FIG. 1 is a side view of a universal ischemic compression device with its universal adapter unit in accordance with an embodiment of the present invention used to attach and extend the reach of an existing pre-owned percussion massage device/percussion massage gun/massage device;

FIG. 2 is a back view of a universal ischemic compression device with its universal adapter unit attached shown in FIG. 1;

FIG. 3 is a right-side view of a universal ischemic compression device with its universal adapter unit attached shown in FIG. 1;

FIGS. 4 and 5 depict a perspective view of a pre-owned or existing percussion massage device of various shapes and sizes attached to a universal ischemic compression device via a universal adapter unit of FIG. 6;

FIG. 6 illustrates a perspective view of one embodiment of a the universal adapter unit (collectively called the docking system) with the perspective of a closed latch;

FIG. 7 illustrates a perspective view of the docking system of FIG. 6 with an opened latch showing the housing where an existing pre-owned percussion massage device may dock;

FIGS. 8 and 10 is a bilateral side view of one embodiment of a universal ischemic compression device with its all-in-one unit (collectively called the-all-in-one) attached;

FIG. 9 is a front view of one embodiment of a universal ischemic compression device with its all-in-one unit of FIG. 8;

FIG. 11 is a side view of one embodiment of a universal ischemic compression device with its hook unit attached;

FIG. 12 is a side exploded view of one embodiment of a universal ischemic compression device without its interchangeable units attached. Illustration includes the unit attachment site, locking mechanism, telescoping interior and exterior poles, and rotating handle bars shown in FIG. 1-3, FIG. 8-11;

FIG. 13 is illustrating a perspective exploded view of the unit attachment site of FIG. 12 in association with the universal adaptor unit shown in FIG. 6 and its connection with the attachable/detachable components which includes the unit attachment site, locking mechanism, and the exterior pole of the embodiment of the present invention shown in FIG. 1-7, and FIG. 12;

FIG. 14 is illustrating a perspective exploded view of the unit attachment site of FIG. 12 in association with FIG. 18 of the all-in-one unit showcasing its connection with the attachable/detachable components which includes the unit attachment site, locking mechanism, the exterior pole, and telescoping fixed cam lock of the embodiment of the present invention shown in FIG. 8-10, and FIG. 12;

FIG. 15 is a illustrating a perspective exploded view of the unit attachment site of FIG. 12 in association with a hook unit demonstrating the attachable/detachable components which includes the unit attachment site, locking mechanism, and the exterior pole of the embodiment of the present invention as shown in FIG. 11;

FIG. 16 represents a side cross-sectional view of 2 inches and FIG. 17 represents a side cross-sectional view of 1.75 inches of one embodiment, which show the motor, power source, and actuation components of a all-in-one unit of FIG. 18;

FIG. 18 is a perspective, exploded view of the housing, motor, power source, and actuation components of the all-in-one unit of FIGS. 16-17;

FIG. 19 depicts a peripheral side view of another embodiment of an adaptive sleeve and a hypothetical pre-existing pre-owned massage device;

FIG. 20 depicts a peripheral side view of a sleeve of FIG. 19 adapting to a handle of a hypothetical pre-owned massage device and a universal adaptor unit with a perspective of an open latch shown in FIG. 7;

FIG. 21 is a multi-positional view of a person using one embodiment of a universal ischemic compression device with its universal adaptor unit attached shown in FIGS. 1-5 with a docked pre-owned massage device as shown in FIGS. 4 and 5. User is self-treating hard to reach areas of the back with ease and precision, and without stressing other parts of the body. Same beneficial outcome is achieved even if the user is in a seated position, standing, or lying down. Using this device requires less upper body and arm movement due to the nature of its shape. Keep shoulders, traps, and back relaxed, grip and hold the pole with the ergonomically elongated handle, position the tip of the massage head on a desired area of the body, sustain treatment uninterruptedly for 30-90 sec on/around inhibited muscle fibers, continue process by moving treatment head around targeting all those difficult to reach muscles such as the back of the shoulder, traps, mid-back and low-back without overstressing other areas of the body.

### DETAILED DESCRIPTION OF THE INVENTION

Many aspects of the invention can be better understood with the references made to the drawings below. The components in the drawings are not necessarily drawn to scale. Instead, emphasis is placed upon clearly illustrating the components of the present invention. Moreover, like reference numerals designate corresponding parts through the several views in the drawings.

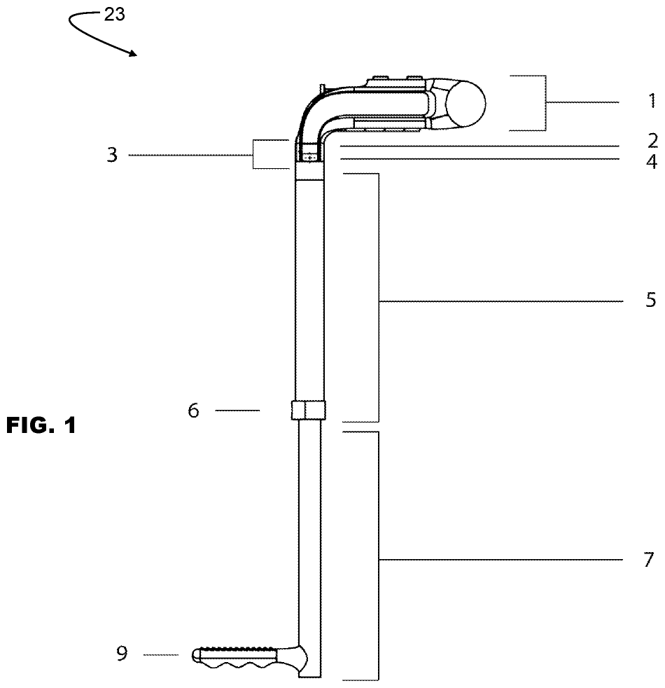

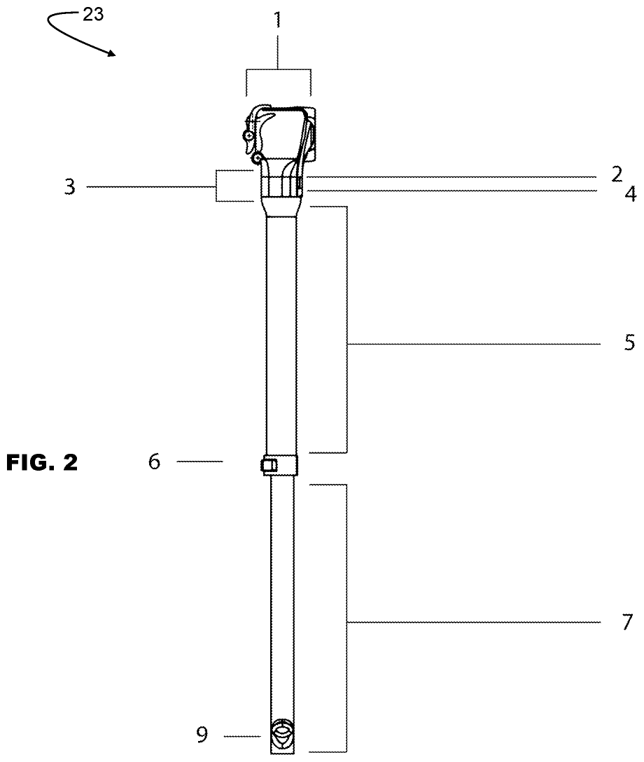

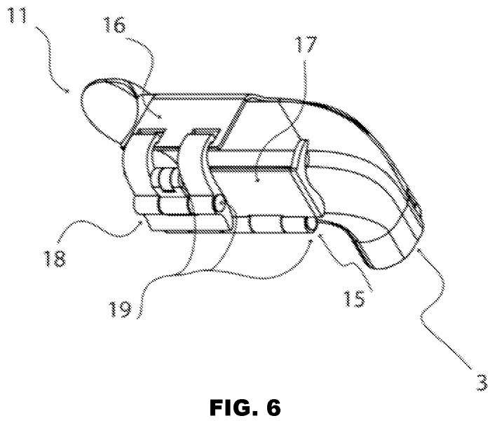

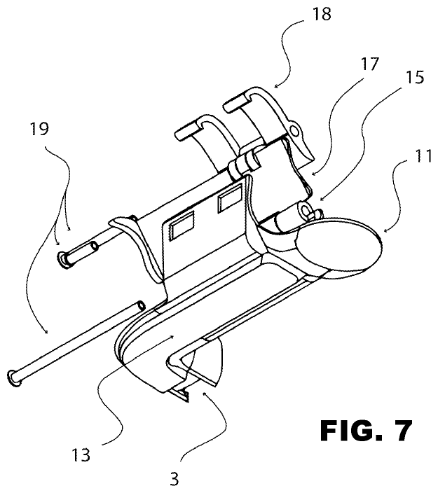

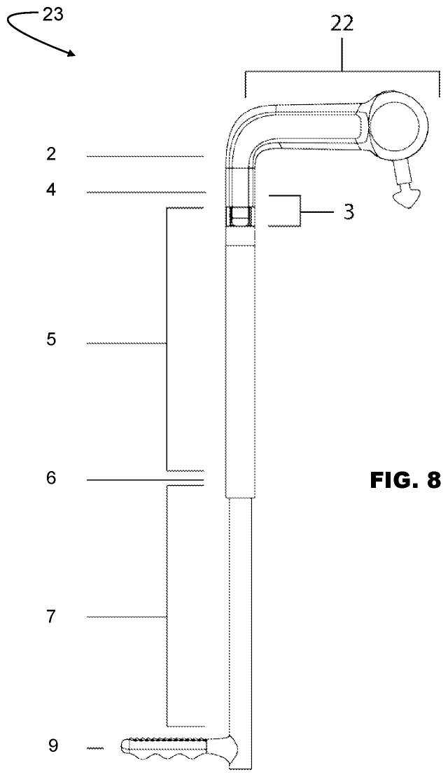

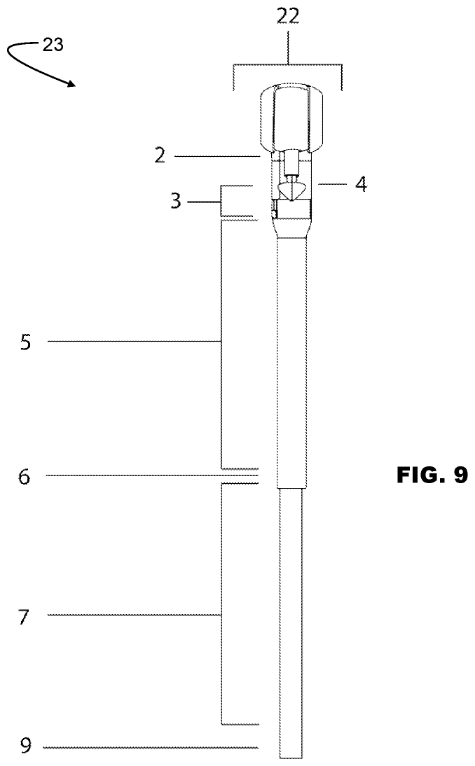

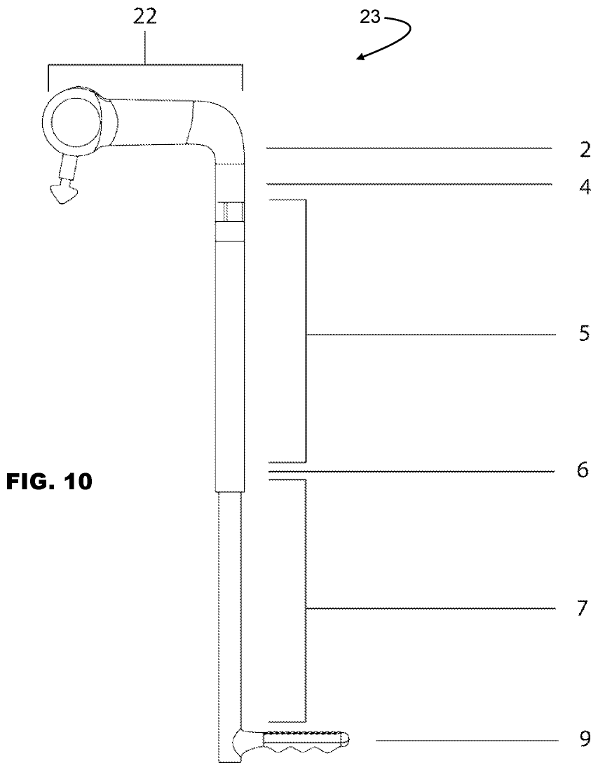

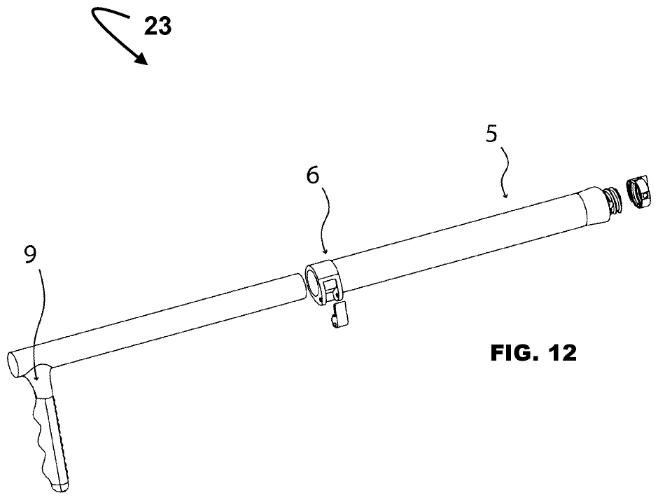

FIGS. 1-3 and 8-12 illustrate various viewpoints of one embodiment of a universal ischemic compression device 23 is depicted with and without the interchangeable units attached 1,21, and 22 (collectively called the interchangeable units). The universal ischemic compression includes a universal adaptor unit 1, all-in-one unit 21, hook unit 22 with massage knobs (a) and massage head (b), a neck 2, a unit attachment site 3, quick release button 4, an exterior pole 5, a fixed cam lock 6, an interior pole-Y 7, a handle 9 which extends the reachability of an existing pre-owned percussion massage device/percussion massage gun/massage device of various shapes and sizes 20, a brace 13 and power source charging station 118. In one embodiment of a universal ischemic compression device 23 with its universal adaptor unit 1 attached is used to securely dock an existing pre-owned massage device 20 via the docking system 15-19 of FIGS. 6-7 (collectively called the docking system) with an adaptive sleeve 24 fulcrum padding along the inside to adapt to the contours of various devices 20 and reduce noise from vibrational motion and translational vibration along the exterior pole 5 to the handle 9. The exterior pole 5 is the outermost section of the pole that remains static and contains the telescoping parts within and allows the apparatus to scale down for ease of transportation. The fixed cam lock 6 is the locking mechanism that controls the extension of interior pole Y 7 and steadily holds the extension in place. The handle 9 is constructed and dimensioned for handheld gripping, and to allow the user to easily and comfortably operate the apparatus and rotate the handle 360 degrees.

FIG. 6 shows an assembled perspective view and FIG. 7 shows an exploded, perspective view of the universal adaptor unit 1 with an open latch perspective. The docking mechanism works by containing the handle of an existing pre-owned massage device 20, such as a percussion therapy device, with and without the use of the adaptive sleeve 24, into the internal diameter of the universal adaptor unit 1. The front brace 17 hinges along the bottom joint/lower lip 16 and secures the existing pre-owned percussion massage device 20 in place when closed. The front brace 17 attaches to the fulcrum latch 18, which attaches to the latch catch/upper lip 16 on the universal adaptor unit 1. Fulcrum latch pins 19 fix the moving parts of the fulcrum latch 18 together and allow the front brace 17 to fully open in order to receive varying sizes of existing pre-owned percussion massage devices 20, then smoothly lock in the closed position. Any existing pre-owned percussion massage device 20 may receive additional directional guidance by the gun head support 11, which prevents the existing pre-owned percussion massage device 20 from shifting during use. The brace runs along the back of the universal adaptor unit 1 and reinforces against shear force that may be applied during use.

In alternative embodiments, the universal adaptor unit 1 may include any material, including but not limited to a flexible polymer, or malleable material with varying sizes. In another embodiment, the universal adaptor unit 1 may be a material and shape and docking system configured to increase the acceptability of a varying existing or pre-owned bodywork devices and massage devices 20 to enhance a therapeutic effect.

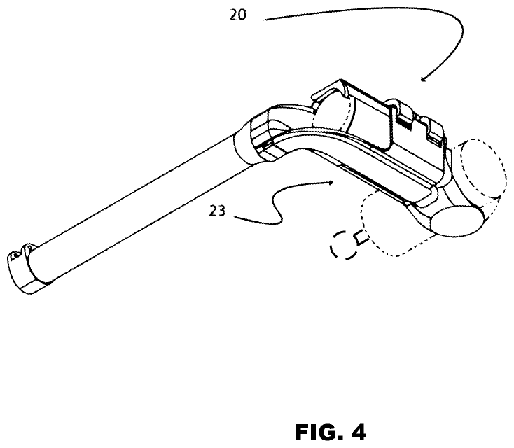

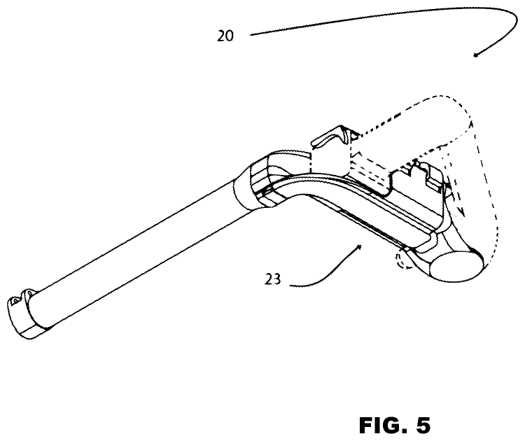

In one embodiment of a universal ischemic compression 23 with a docked existing pre-owned massage device 20 locked-in to a universal adaptor unit 1. Although FIGS. 4 and 5 depict two variations of existing pre-owned massage device 20 being used to dock, a universal adaptor unit 1, its docking system 15-19, and adaptive sleeve and fulcrum padding 24 is capable of accepting different shapes and sizes such as, but not limited to: L shaped to varying degrees, T shaped to varying degrees or a triangular shape to varying degrees, lengths, grip dimensions, and adjustable speed capabilities via a docking system 15-19, an adaptive sleeve and fulcrum padding 24 and interchangeable padded lining strips. In alternative embodiments, the adaptive sleeve and fulcrum padding 24 may include varying material and configurations for improved adaptability but functions to achieve acceptability of diverse therapy devices.

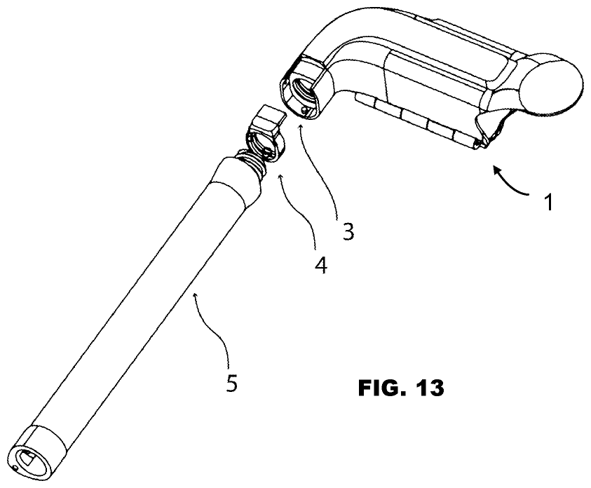

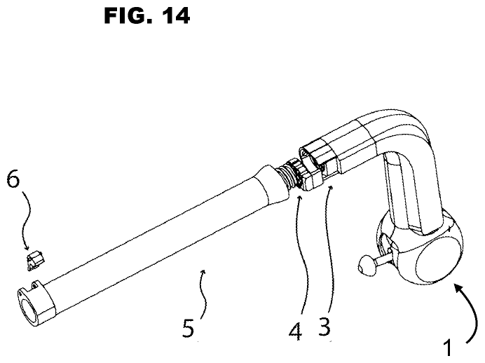

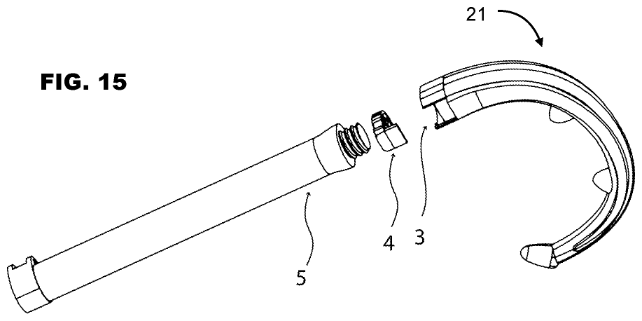

FIGS. 13-15 depict embodiment of a universal ischemic compression 23 interacting with the interchangeable units 1, 21, and 22, showing its connection with the a unit attachment site 3, quick release button 4, an exterior pole 5, and telescoping fixed cam lock 6 (collectively called the attachable/detachable/telescoping components).

In alternative embodiments, the unit attachment site 3 may include a bolt mechanism to interact with a key on an attachment piece or unit. For example: the mechanism may secure and lock the unit attachments by selectively opening and closing via articulation of the bolt mechanism.

In alternative embodiments of interchangeable unit 1, 21, and 22 may include shapes and sizes to address the framework of different body parts and therapeutic needs. For an example: an interchangeable unit may include suction apparatus for the purpose of cupping and decompression therapy and may be made of material suitable for human flesh and treatment needs. An interchangeable unit may also include and/or adapt to a varying trigger point release apparati. For example: the hook unit 21a-21b may include other hooks, knobs heads and gripping access for enhanced ischemic pressure and therapeutic outcomes.

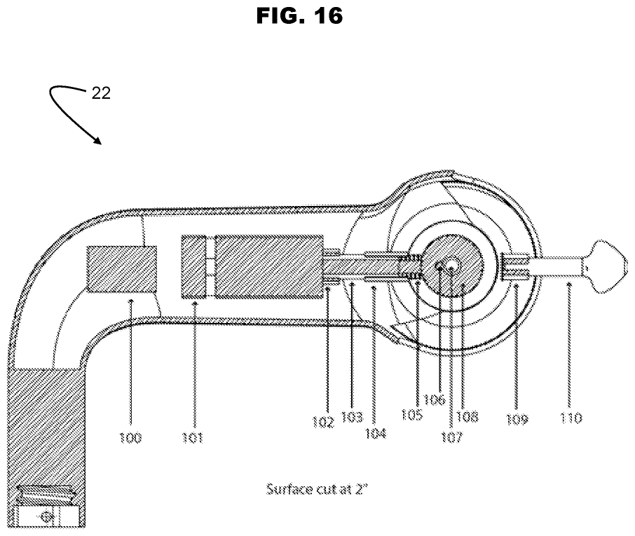

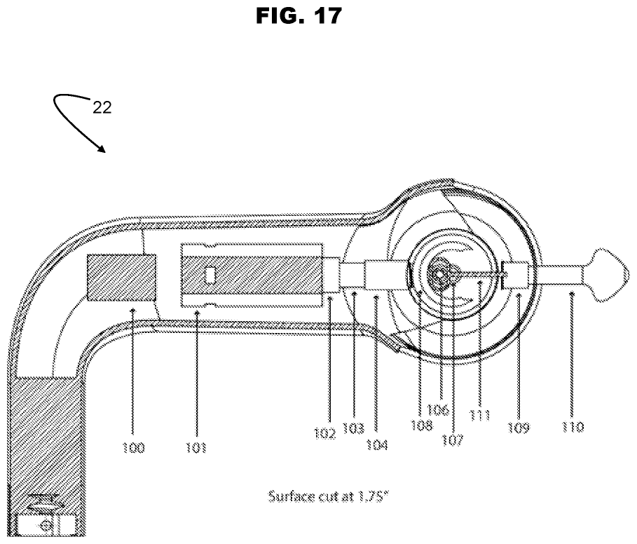

FIGS. 16 and 17 show cutaways in the sagittal plane at various depths showcasing the relationship of internal components for an embodiment of a all-in-one unit 22. The all-in-one unit 22 is depicted with the massage head 110 positioned at a 180 degree angle from the handle; the direction of the massage head 110 may vary up to 180 degrees along a rotational path, which can be locked in place to reach more parts of the body.

FIG. 17 depicts a cutaway at a depth of 1.75 inches to show the same internal components of a all-in-one unit 22 at a higher level, which is necessary to describe the line of mechanical relationships that actuate percussion motion of the massage head 110. The pin in off-center opening 106 on the gear member counterweight 108 spins around the axle 107 at a wider orbit and attaches to the gear member 111, secured via the pin sleeve 117. The elliptical motion between the pin in off-center opening 106 and gear member 111 is transferred into percussive force through the length of the gear member 111, which attaches to the rotating massage head receiver 109. Various massage heads 110 can be alternated by inserting into the rotating massage head receiver 109.

FIG. 16 depicts a power source 100 powers the motor 101 which causes the shaft 103 to spin. The compliant shaft damper 102 is fixed to the motor and maintains a steady position of the moving shift 103. The shaft 103 reaches into the gearbox 104, where the threaded end of the shaft gear 105 contacts the threads in the gear member counterweight 108, shifting rotational energy from the shaft 103 to the gearbox 104 components. In the center of the gearbox 104 chamber, an axle 107 maintains rotational motion of component parts about a central axis. The spinning gear member counterweight 108 contains the pin in off-center opening 106, which revolves around the axle 107.

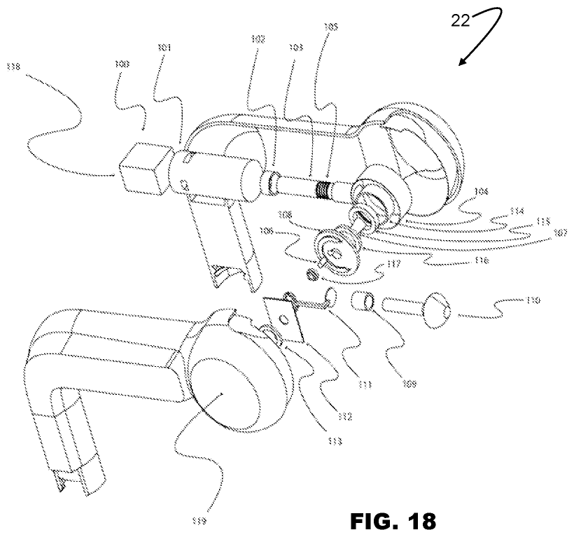

FIG. 18 is the exploded view of the all-in-one unit 22 (generally referred to as the “housing unit”) that shows the relationships of mechanical components within and how they may interact to actuate percussive force. In some embodiments, the motor 101 operates at a speed that can be varied by different levels determined on the control panel for operation 119. The motor 101, in one embodiment, may convert rotational force from the power source 100 into percussive motion in the massage head 110. The power source 100 can be made of any type of power source capable of supplying power to the motor 101. In some embodiments, the motor 101 is an electric motor. The electric motor may be any type of electric motor known in the art, including, but not limited to, a brushed motor, a brushless motor, a direct current (DC) motor, an alternating current (AC) motor, an externally commutated motor, a mechanical-commutator motor, or an electronic commutator motor. The rotary motion delivered by the motor 101 may be delivered through a shaft 103. In some embodiments, the all-in-one unit 22 may include a linkage to convert the rotary motion of the motor 101 into a reciprocating motion. In an alternative embodiment, the motor 101 may produce reciprocating motion. For example, the motor 101 may include a reciprocating air-powered pneumatic reciprocating cylinder. The mechanical motion of the massage head 110, in some embodiments, reciprocates in response to an input from the motor 101. For example, the motor 101 may produce rotary motion that is transmitted to reciprocating motion. The gearbox 104 may be connected to the massage head 110 and assist in the transmission of motion from rotational force to percussive force.

In some embodiments, the motor 101 is connected to the housing of the all-in-one unit 22 such that the shaft 103 is perpendicular to the reciprocating axle 107 (pictured in FIGS. 16 and 17).

As shown in FIG. 18, in a preferred embodiment, eccentric motion is conveyed by a pin in off-center opening 106 defined in or through the gear member 111. The pin sleeve 117 is received in an extended opening of the gear member 111 that connects to a rotating massage head receiver 109.

In one embodiment, the gear member counterweight 108 interfaces with a reciprocator interface or containment member 112. The containment member 112 contains the head of the axle 107 and designates a reciprocation space in which the axle 107 and related components can move. The containment member 112 in a preferred embodiment rotates with the massage head 110 to deliver percussive force in a range of angles. Inner structural components include the bearing 115 and bearing housing 114, which exist to maintain positioning and reduce friction of moving components within the gearbox 104.

In other embodiments, the effect of interaction between the eccentric motion of the gear member counterweight 108 and the containment member 112 may convert rotary motion at the gear member 111 to reciprocating, linear motion at the rotating massage head receiver 109 and through the massage head 110. The gear member 111 relays reciprocating, linear motion of the percussive force of the massage head 110.

In one embodiment, the gear member 111 may include a gear member counterweight 108, which is configured to oppose inertial forces generated by the reciprocating motion of the percussive force in the massage head 110. The counterweight 108 is located on one side of the gear member 111 and the gear teeth are located on the opposite side (pictured in FIGS. 16-18). In another embodiment, the gear and counterweight can potentially be organized in separate parts and order.

In some embodiments, as the all-in-one unit 22 percussion device operates, the gear member counterweight 108 applies at least a component of force in the opposite direction to a reaction force applied to the eccentric motion of the counterweight 108. In other words, the counterweight 108 may serve to counteract an inertial force generated by reciprocating components and reduce vibration caused by reciprocal motion of the massage head 110. In alternative embodiments, the counterweight 108 may be in different sizes to match reciprocating components of the all-in-one unit 22.

The gearbox 104, in one embodiment, includes the gear member 111 which consists of an elongated opening and reciprocating arm. The gearbox 104 may provide mounting points for the gear member 111. The gearbox 104 may restrict the motion of the gear member 111 to certain directions or rotational axes. The gearbox 104 may be mounted to the housing of the all-in-one unit 22. In some embodiments, the gearbox 104 is separated from the housing of the all-in-one unit 22 by the one or more compliant damping rings 113.

In some embodiments, the percussive force of the massage head 110 and associated components is rotatable relative to the housing of the all-in-one unit 22. The percussive force of the massage head 110 may rotate relative to the housing of the all-in-one unit 22 around an output rotation axis.

In one embodiment, a user may selectively lock and unlock the orientation of the massage head 110. For example, the user may unlock rotation of the massage head 110, rotate the massage head 110 to a desired position relative to the housing of the all-in-one device 22, lock rotation of the massage head 110, and operate the percussion capabilities of the all-in-one unit 22, then unlock and reorient again.

Massage heads 110 provide modifiable measures of percussive force with various lengths. The percussive force of the massage head 110 may be configured to have any amplitude as determined by the individual operating the all-in-one unit 22. In other embodiments, alternating massage heads (not shown) can be mounted on the rotating massage head receiver 109; For example, alternating massage heads may include, but not be limited to: cone tip, cylindrical tip, flat tip, fork point tip, small size EVA ball tip, large size EVA ball tip, spade tip, extended rod tip.

In various embodiments, the massage head 110 may actuate at a range of Hz determined by the motor 101, gearbox 104 transfers of force, and component parts. The preferred embodiment should cause the massage head 110 to articulate or reciprocate at a frequency between 30 Hz and 45 Hz.

In certain embodiments, the percussive force of the massage head 110 reciprocates along a linear or substantially linear path. The path traveled by the massage head 110 defines a reciprocation axis on the axle 107. In certain embodiments, the axle 107 runs through the center of one or more internal components.

The one or more compliant dampening rings 113 manage vibration conducted from the actuation components to the housing of the all-in-one unit 22. The one or more compliant dampening rings 113 may be disposed between the actuation components and housing of the all-in-one unit 22. The one or more compliant dampening rings 113 may consist of material capable of absorbing vibration. In some embodiments, the one or more compliant dampening rings 113 may include polymers, flexible polymers, elastomers, polyurethane foams, thermoplastic elastomers, PVC's, or urethanes.

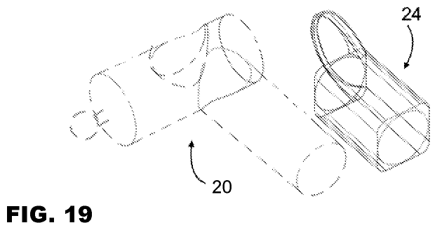

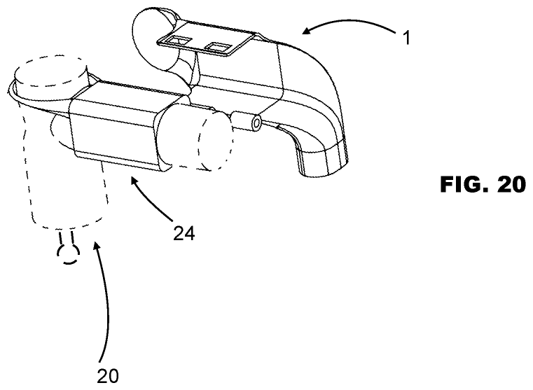

FIGS. 19 and 20 illustrates a hypothetical pre-owned generic device 20 capable of configuring with the universal adaptor unit 1 of the Universal Ischemic Compression Device 23 via an adaptive sleeve 24. The shape of pre-owned devices may vary, so for devices that are smaller than the internal diameter of the universal adaptor unit 1, an adjustable sleeve 24 may be supplemented to ensure adaptability, steadiness, and reduce vibration.

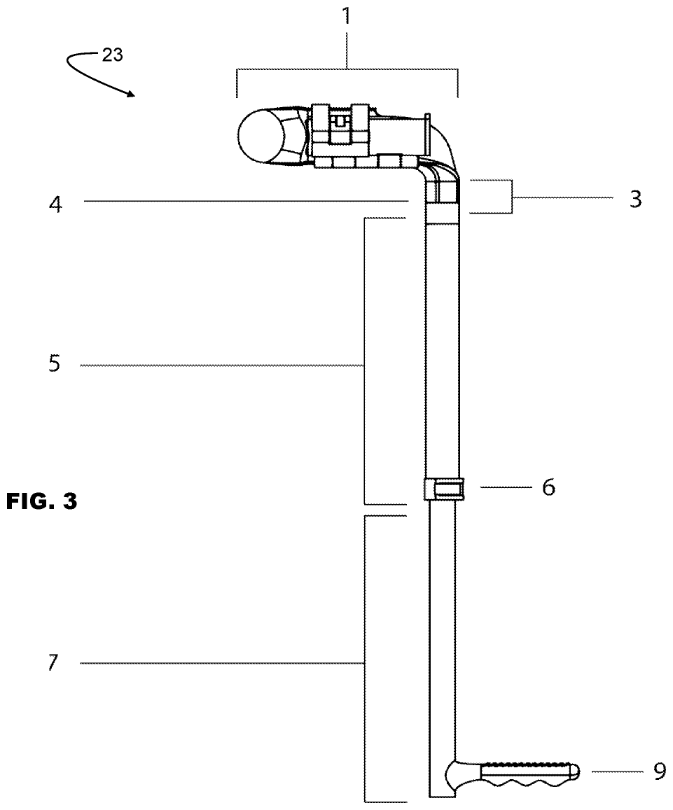

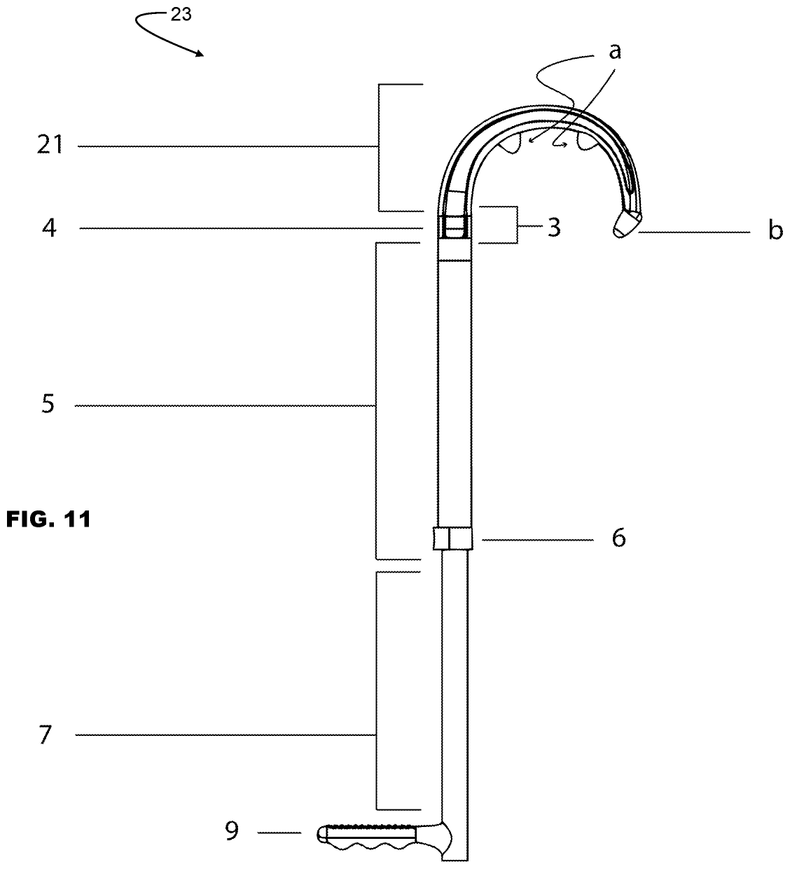

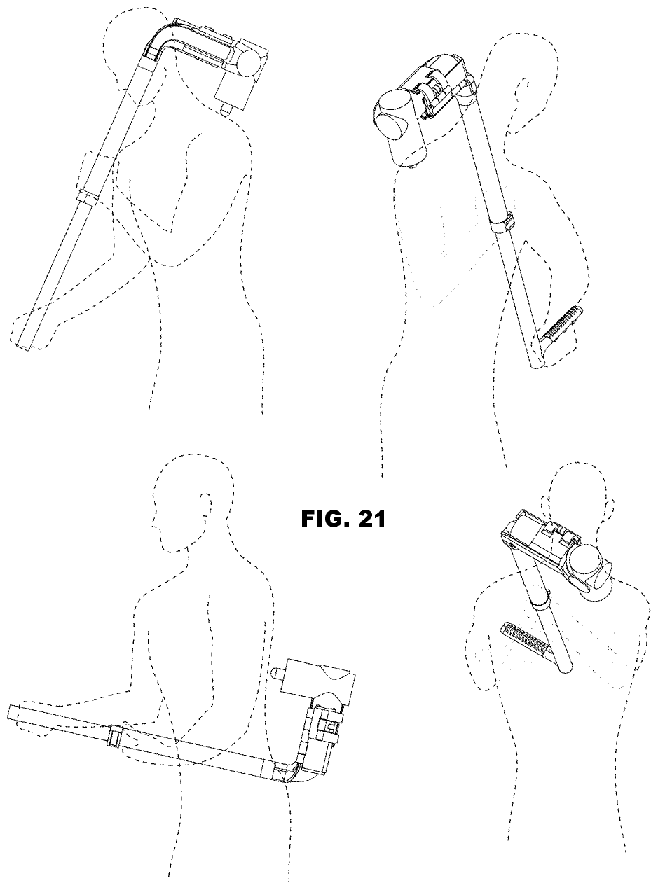

FIG. 21 illustrates a person using one embodiment of a universal ischemic compression device with its universal adaptor unit 22 and a docked pre-owned massage device 20 as shown in FIGS. 4 and 5. In this demonstration, the user is self-treating the posterior aspects of the shoulders, upper and mid trapezius, thoracic region, and mid-low back while maintaining <90 degrees of shoulder flexion bilaterally. In other words, a user is enabled to treat most of his/her back while maintaining neutral posture with precision, and without added stress on other parts of the body. The same beneficial outcome is achieved even if the user is in a seated position, standing, or lying down. Keeping shoulders, traps, and back relaxed, user grips the pole and handle which are customizable to their anthropometrics, positions the tip of the massage head of the existing pre-owned massage device 20 (or massage head 110 of a all-in-one unit 22 as shown in FIG. 3-3B or hook unit 21 massage head 21b as shown in FIG. 11—not shown in FIG. 21) on a desired area of the body, sustains treatment for 30-90 sec on/around inhibited muscle fibers, then continues the process by moving massage head to needed areas. Custom extension enables individual users to reach affected muscles on both the anterior and posterior sides of the body, without overburdening supporting muscles. The positions depicted in FIG. 21 indicate just a few examples of potential methods of use for the universal ischemic compression device 23, however do not encapsulate all iterations of potential use.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

What I claim is:

1. A device for self-massage therapy, comprising: a head, a neck, a pole and a handle, where the head comprises a 90-degree bend, where the head comprises an interchangeable treatment unit, where the head is connected to the pole at the neck, with the handle is attached to a bottom end of the pole, where the pole allows the handle to rotate 360 degrees, where the neck additionally comprises a quick-release button by which the head can be quickly removed from the pole, where the pole comprises an exterior pole and an interior pole, where the interior pole is telescopically adjustable within the exterior pole, where the pole additionally comprises a fixed cam lock, where the fixed cam lock is located at a bottom of the exterior pole, and where the fixed cam lock removably secures the interior pole at a desired length to allow for use of the device as a self-massager, where the handle comprises a grip portion, where the grip portion provides a grip to the user, where a, where a motor control unit controls a percussive cadence, frequency and a strength of a massage bit.

2. The device of claim 1, where the interchangeable treatment unit is a percussive device, where the head comprises a motor and a universal bit adaptor capable of accepting and removably securing a wide range of massage therapy bits, where the percussion device delivers a massage to the user, and where the motor drives the percussion device.

3. The device of claim 1, where the interchangeable treatment unit is a pre-existing massage device and where the head additionally comprises a universal adaptor, where the universal adaptor allows attachability of the pre-existing massage device

4. The device of claim 1, where the interchangeable treatment unit is a hook-like static massage unit.

5. A device for self-massage therapy, comprising: a head, a neck, a pole and a handle, where the head comprises a 90-degree bend, where the head comprises one or more interchangeable treatment units, where the head is connected to the pole at the neck, with the handle is attached to a bottom end of the pole.

6. The device of claim 5, where the one or more interchangeable treatment units is selected from the group consisting of percussive device, a universal adaptor, and a hook-like static massage unit.

7. The device of claim 5, where the neck additionally comprises a quick-release button by which the head can be quickly removed from the pole.

8. The device of claim 7, where the pole comprises an exterior pole and an interior pole, where the interior pole is telescopically adjustable within the exterior pole.

9. The device of claim 8, where the pole additionally comprises a fixed cam lock, where the fixed cam lock is located at a bottom of the exterior pole, and where the fixed cam lock removably secures the interior pole at a desired length and allows the handle to rotate 360 degrees which allows for use of the device as a self-massager.

10. The device of claim 9, where the handle comprises a grip portion, where the grip portion provides a grip to the user, where the grip portion comprises a plurality of indentations on a bottom side of the grip portion, where the grip portion comprises a plurality of ridges on a top side of the grip portion.

11. The device of claim 10, where a motor control unit controls a percussive cadence, frequency and a strength of a massage bit.

12. The device of claim 11, where the one or more interchangeable treatment units is a percussive device, where the head comprises a motor, where the percussion device delivers a massage to the user, and where the motor drives the percussion device.

13. The device of claim 12, where the head comprises a power source, a motor, a compliant shape dampener, a gearbox, a shaft gear, a pin in off-center opening, an axel, a gear member counterweight, a rotating massage head receiver and a massage head.

14. The device of claim 13, where the head additionally comprises a power source/charging station, a bearing housing, a containment member, a dampening ring, a control panel, a washer, a pin sleeve and a bearing housing.

15. The device of claim 14, where the percussive device is a massage therapy bit, and the massage therapy bit is selected from—the group consisting of cone tip, cylindrical tip, flat tip, fork point tip, small size EVA ball tip, large size EVA ball tip, spade tip, extended rod tip.

16. The device of claim 11, where the head comprises a universal adaptor unit, and where the one or more interchangeable treatment units is the universal adaptor unit, where the universal adapter unit is capable of accepting and removably securing a wide range of pre-existing massage therapy devices, where the universal adaptor unit comprises padded linings and strips run along the inside to adapt to the contours of various devices, a malleable front brace hinges along the bottom joint/lower lip to secures a pre-existing massage therapy devices in place when closed, where front brace attaches to the fulcrum latch, where the fulcrum latch attaches to the latch catch/upper lip in order to receive varying sizes of existing a pre-existing massage therapy devices.

17. The device of claim 16, where the head is connected to the pole at the neck, with the handle is attached to a bottom end of the pole, where the head securely configures to a wide range of pre-existing massage therapy, where the neck is attached and locked-in to the exterior pole, where the interior pole is telescoped to an extended length, where the handle is attached to the bottom end of the interior pole, where the handle comprises a grip portion, where the grip portion provides a grip to the user.

18. The device of claim 17, where the head additionally comprises a sleeve and a padding section, where the padding section lines the sleeve.

19. The device of claim 11, where the one or more interchangeable treatment units is a hook-like static massage unit, where the hook shape is a roughly semi-circular curve with one or more massage knobs and one or more massage heads at an end of the hook.

20. The device of claim 11, where the head comprises a universal adaptor unit.
